(19) United States
(12) Patent Application Publication
(10) Pub. No.: US 2005/0130508 A1
(43) Pub. Date: Jun. 16, 2005

(54) Structure of connector

(76) Inventor: Sheng-Hsing Yeh, Hsi-Chih City (TW)

Correspondence Address: TROXELL LAW OFFICE PLLC, SUITE 1404, 5205 LEESBURG PIKE, FALLS CHURCH, VA, 22041, US

(21) Appl. No.: 10/731,504

(22) Filed: Dec. 10, 2003

(51) Int. Cl. H01R 9/22

(52) U.S. Cl. 439/709

(57) ABSTRACT

A connector includes a housing forming at least one receptacle and a terminal received in each receptacle. The housing has upper and lower faces in which opposite slots are defined. Through holes are defined in the slots and extending to the receptacle. The terminal has an engagement section, a retention section extending from the engagement section, an extension section extending from the retention section and opposite to the engagement section and a wire engaging section projecting from the extension section. The engagement section includes a plurality of circumferentially spaced resilient leaves forming a cylinder axially aligned with the holes defined in the upper and lower faces of the housing. Thus, when a pin of a mating connector is fit into the cylinder of the engagement section through either one of the holes of the housing, the pin is completely surrounded by the leaves and a large contact area is formed between the pin and the engagement section. Due to the resiliency of the leaves, only a low insertion force is needed in completing insertion of the pin into the engagement section. Firm engagement, low impedance and low noise, as well as reduced heat generation, can be realized between the pin and the engagement section.

### FIELD OF THE INVENTION

The present invention generally relates to a structure of connector, and in particular to a socket connector that features low insertion force and firm engagement with a mating plug connector with low electrical impedance, low noise and reduced heat generated.

### BACKGROUND OF THE INVENTION

Electrical connectors are known, such as U.S. Pat. No. 5,314,360 which claims a terminal block comprising: at least one clamp body having a front end and a rear face; a conductor receiving passage extending within said clamp body between said front end and said rear face, a bore within said clamp body, said bore receiving a binding post; a terminal housing with at least one mounting unit, said unit having a front opening and a bushing aperture, an interior part extending within said terminal housing from said front opening to said bushing aperture; a conductor protection element including at least a free leg, a plurality of contact blades, and said conductor protection element and said plurality of the contact blades being formed as one coherent unit; whereby said clamp body is insertable into said interior part of the housing through said front opening, in an assembled condition of said terminal block at least said free leg of said conductor protection element being situated within said conductor receiving passage and said plurality of contact blades is situated within said bushing aperture adjacent to said rear face of said clamp body.

The contact blades of the protection element are bent toward the same direction and forming a triangle. An opening is formed at an apex of the triangle. By means of the opening, a clamping force is provided when a pin of a plug connector (not shown) is inserted into the terminal block. Although engagement can be effectively formed between the inserted pin and the conductor protection element of the terminal block, since the protection element has a triangular configuration with an opening and since the pin has a post-like configuration, when the pin is inserted into the conductor protection element, the conductor protection element hardly completely surrounds the pin, forming a gap therebetween and thus reducing the area of contact between the pin and the conductor protection element, which results in unstable engagement, high electrical impedance, high noise and increased heat generated thereby.

Another known structure of socket connector is shown in FIG. 6 of the attached drawings, comprising a block 5 having a side face in which at least one receptacle 51 is formed and an opposite side face and a bottom face in both of which holes (not shown) in communication with the receptacle 51 are formed. A terminal 6 is received and fixed in the receptacle 51. The terminal 6 comprises an engagement section 61 and a retention section 62. The engagement section 61 has a substantially U-shaped cross section having a central face and two side faces with a rectangular opening 611 defined in the central face. The engagement section 61 is so formed as to receive insertion of a pin of a plug connector (not shown) to form engagement therebetween.

Although engagement can be formed between the pin of the plug connector and the engagement section 61 of the terminal 6 of the socket connector, since the engagement section 61 has a U-shaped cross section and since the pin has a post-like configuration, when the pin is inserted from an end of the engagement section 61 into the engagement section 61, the engagement section 61 cannot completely surround the pin with a bottom side that is the opening of the U shape forming no engagement with the pin, resulting in small contact area between the pin and the terminal 6.

In addition, when the pin is inserted in a direction through the rectangular opening 611 of the engagement section 61, similarly small contact area is resulted. Both causes unstable engagement between the pin and the terminal, which in turn results in high impedance and high noise and increased heat generated between the pin and the terminal.

Thus, it is desired to have a structure of connector that overcomes, or at least alleviates, the drawbacks of the conventional connectors.

### SUMMARY OF THE INVENTION

Thus, a primary objective of the present invention is to provide a structure of socket connector that provides a large contact area with a pin of a plug connector and has a low insertion force to realize firm engagement between the plug connector and the socket connector.

To achieve the above objective, in accordance with one aspect of the present invention, a connector comprises a housing having a rear face forming at least one receptacle and upper and lower faces each forming a slot, a hole being defined in each slot and extending through the upper and lower faces into the receptacle, a securing hole being defined in the upper face and in communication with the receptacle; a terminal received in each receptacle of the housing, the terminal comprising an engagement section, a retention section extending from the engagement section, an extension section extending from the retention section and opposite to the engagement section and a wire engaging section projecting from the extension section, the engagement section comprising opposite side wings and a plurality of resilient leaves extending from each side wing and spaced from each other in the direction of the side wing, the side wings being bent so that the leaves form a substantially cylindrical configuration in axial alignment with the holes defined in the slots. Thus firm engagement, low insertion force, low impedance, reduced noise and reduce heat generation can be realized between the connector and a mating connector.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a connector constructed in accordance with the present invention;

FIG. 2 an exploded view of the connector of the present invention;

FIG. 3 is a development view of a terminal of the connector in accordance with the present invention;

FIG. 4 is a side elevational view with portion of a housing removed to show inside details, illustrating a first way of connection of a mating connector to the connector of the optic mouse of the present invention;

FIG. 5 is similar to FIG. 4, but showing a second way of connection of the mating connector to the connector of the present invention; and

FIG. 6 is an exploded view of a conventional connector.

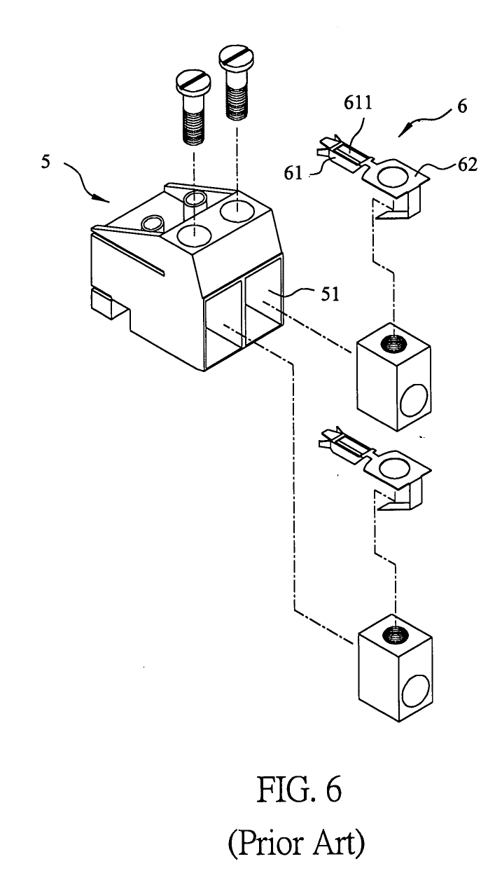

### DETAILED DESCRIPTION OF THE PREFERRED EMBODIMENT

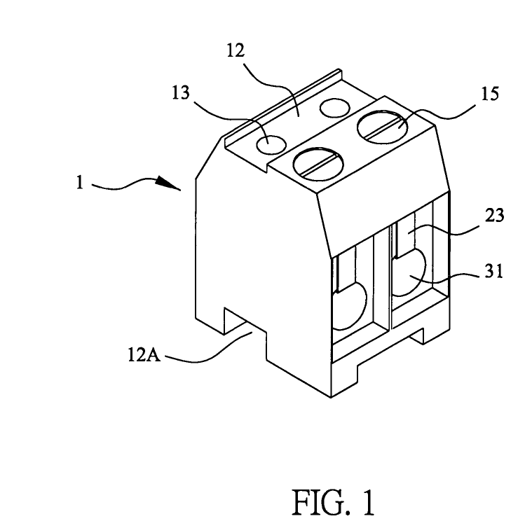

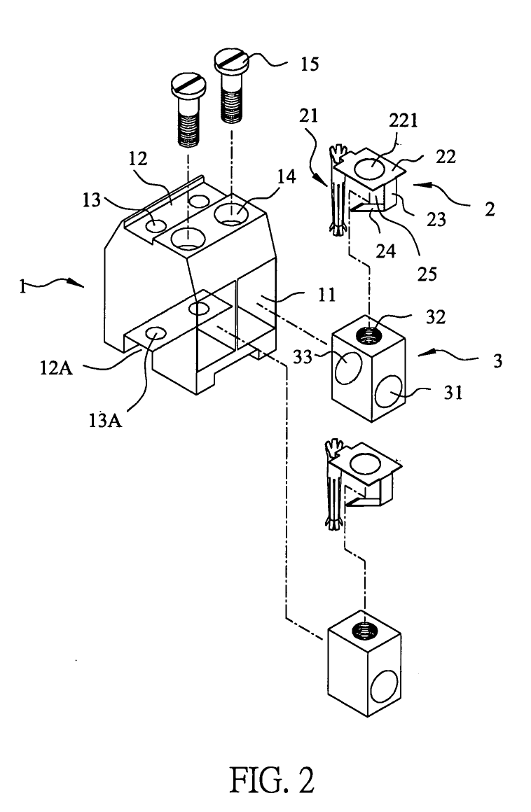

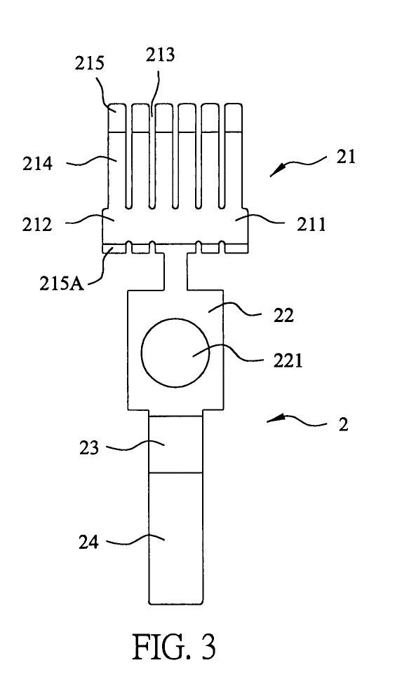

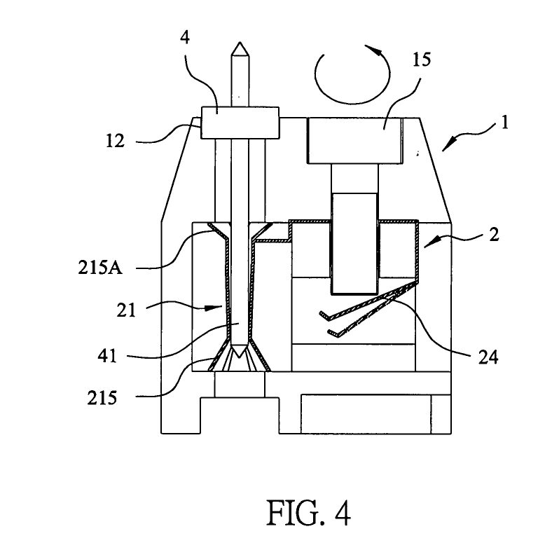

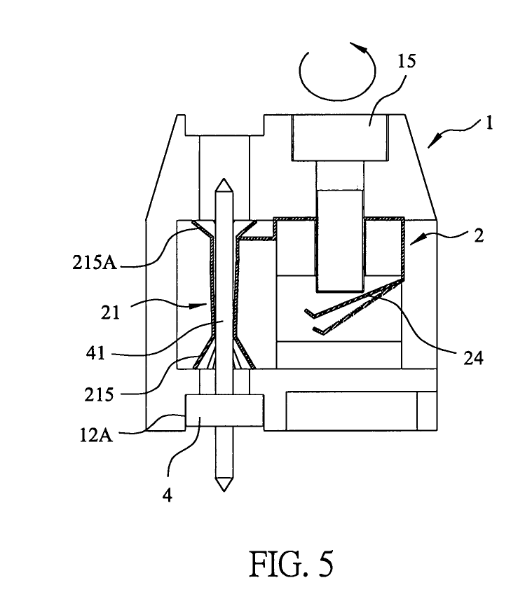

With reference to the drawings and in particular to FIGS. 1-3, a socket connector constructed in accordance with the present invention comprises a housing 1, made of insulation material, and at least one terminal 2, for mating a plug connector 4 (see FIGS. 4 and 5) with a low insertion force and firm engagement to thereby reduce impedance and noise and heat generated between the socket connector and the plug connector.

The housing 1 has a rear face (not labeled) in which at least one receptacle 11 is formed for receiving the terminal 2 therein. In the embodiment illustrated, two receptacles 11 are formed in the rear face of housing 1 and two terminals 2 are received in the receptacles 11. The housing 1 also has upper and lower faces (not labeled) in which slots 12, 12A, which are opposite to each other, are respectively formed and extending between opposite side faces of the housing 1. Through holes 13, 13A are respectively formed in the slots 12, 12A and extending through the upper and lower faces of the housing 1 and into the receptacles 11 respectively. A securing hole 14 is defined in the upper face of the housing 1 and extending into each receptacle 11.

The terminal 2 comprises an engagement section 21, a retention section 22 connected to the engagement section 21, preferably by means of a neck (not labeled), an extension section 23 extending from the retention section 22 and opposite to the engagement 21 and a wire engaging section 24 further extending from the extension section 23. The engagement section 21 comprises left and right wings 211, 212 extending in opposite directions from opposite sides of the neck, and a plurality of spring leaves 214 extending from each wing 211, 212 and spaced (as indicated by reference numeral 213) in the direction of the wings 211, 212. The wings 211, 212 are bent to form a circle whereby the leaves 214 form a cylinder and spaced in a circumferential direction of the cylinder. The engagement section 21 so formed as a cylinder is positioned in the receptacle 11 and in axial alignment with the holes 13, 13A defined in the upper and lower faces of the housing 1.

The leaves 214 of the engagement section 21 converges to each other in the direction toward free ends of the leaves 214 whereby the cylinder of the engagement section 21 has a gradually reduced inside diameter. Further, the free end of each leaf 214 is bent outward to form a lead-in section 215. Similar lead-in sections 215A are formed on the wings 211, 212 substantially opposite to the lead-in sections 215 of the leaves 214.

The retention section 22 is bent to be substantially perpendicular to the axial direction of the engagement section 21, while the extension section 23 and the wire engaging section 24 are further bent so that the wire engaging section 24 is substantially parallel to the retention section 22. A constraint zone 25 is thus formed between the retention section 22, the extension section 23 and the wire engaging section 24, which receives a securing block 3 therein.

A hole 221 is defined in the retention section 22 and substantially aligns with the securing hole 14 of the housing 1.

The block 3 has a rear face, an upper face and a side face in which holes 31, 32, 33 are respectively formed and in communication with each other. The rear hole 31 receives the wire engaging section 24 of the terminal 2 therein. A fastener 15, such a bolt, extends through the securing hole 14 of the housing and the hole 221 of the terminal 2 to engage the hole 32 of the block 3. Preferably, the hole 32 is internally threaded for threadingly engaging the bolt 15 thereby securing the block 3 and the terminal 2 in the receptacle 11 of the housing 1.

Also referring to FIGS. 4 and 5, a conductor, such as a wire (not shown), is inserted into the hole 31 of the block 3. The fastener 5 is sized to have a tip end thereof engage and depress the wire engaging section 24 of the terminal 2 against the wire thereby forming secure electrical engagement therebetween. This can be simply done by tightening the bolt 15 in the internally threaded hole 32 of the block 3.

To mate the plug connector 4 with the socket connector of the present invention, a pin 41 of the plug connector 4 can be fit into either hole 13, 13A formed in the upper or lower faces of the housing 1. If the pin 41 is fit into the hole 13 of the upper face of the housing 1, the pin 41 is guided by the lead-in sections 215A of the terminal 2 into the cylinder formed by the leaves 214 thereby electrically engaging the leaves 214, especially due to the reduced diameter of the cylinder of the engagement section 21. On the other hand, when the pin 41 is fit into the hole 13A of the lower face of the housing 1, the pin 41 is guided by the lead-in sections 215 of the leaves 214 into engagement with the leaves 214. Due to the lead-in sections 215, 215A and the resiliency of the leaves 214, a low insertion force is required in mating the pin 41 with the engagement section 21. Further, since the leaves 214 of the engagement section 21 is arranged to form a cylinder, a substantially complete surrounding of the pin 41 by the leaves 214 is realized in the present invention and the maximum contact area is formed between the pin 41 and the engagement section 21. As a result, impedance between the pin 41 and the engagement section 21 is reduced, noise caused thereby is also reduced and heat generated between the pin 41 and the engagement section 21 is also reduced due to the reduced impedance therebetween.

Although the present invention has been described with reference to the preferred embodiment thereof, it is apparent to those skilled in the art that a variety of modifications and changes may be made without departing from the scope of the present invention which is intended to be defined by the appended claims.

1. A connector comprising:
a housing having a rear face forming at least one receptacle and upper and lower faces each forming a slot, a hole being defined in each slot and extending through the upper and lower faces into the receptacle, a securing hole being defined in the upper face and in communication with the receptacle;
a terminal received in each receptacle of the housing, the terminal comprising an engagement section, a retention section extending from the engagement section, an extension section extending from the retention section and opposite to the engagement section and a wire engaging section projecting from the extension section, the engagement section comprising opposite side wings and a plurality of resilient leaves extending from each side wing and spaced from each other in the direction of the side wing, the side wings being bent so that the leaves form a substantially cylindrical configuration in axial alignment with the holes defined in the slots, opposite axial ends of the engagement section forming lead-ins.

2. The connector as claimed in claim 1, wherein the leaves converge toward each other in a direction toward free ends thereof whereby inside diameter of the engagement section is gradually reduced toward the free ends of the leaves.

3. The connector as claimed claim 1, wherein the wire engaging section of the terminal is substantially parallel to the retention section whereby a constraint zone is formed between the retention section, the extension section and the wire engaging section of the terminal, a hole being defined in the retention section and corresponding in position to the securing hole of the housing.

4. The connector as claimed claim 3, wherein the constraint zone receives a block therein, the block having three faces in which holes are defined and in communication with each other, the wire engaging section of the terminal being received in one of the holes of the block, a fastener extending through the securing hole of the housing and the hole of the retention section of the terminal and engaging one of the holes of the block to secure the terminal in the housing, the fastener having a tip end engaging and depressing the wire engaging section of the terminal.
